(19) United States
(12) Patent Application Publication
(10) Pub. No.: US 2012/0310779 A1
(43) Pub. Date: Dec. 6, 2012

(54) Electronic Commercial Transaction Systems and Methods for Soliciting and Collecting Gratuities and Donations

(76) Inventor: Matt Flynn, Raleigh, NC (US)

(21) Appl. No.: 13/118,808

(22) Filed: May 31, 2011

(51) Int. Cl. G06Q 20/22; G06Q 30/06; A63F 9/24; G06Q 40/06

(52) U.S. Cl. 705/26.43; 705/27.1; 705/37; 463/12; 463/13; 463/22; 463/20; 463/25

(57) ABSTRACT

An electronic commercial transaction system and associated methods, in which the transaction is conducted concurrently with or followed by a solicitation for either a gratuity for the seller or a charitable donation to be forwarded to a third party beneficiary.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The field of the invention is an electronic commercial transaction system and associated methods, in which the transaction is conducted concurrently with a solicitation for either a gratuity for the seller or a charitable donation to be forwarded to a third party beneficiary.

2. Background of the Invention

The practice of giving gratuities for service in business transactions is widespread and is especially prevalent in certain industries involving personal service, notably food and beverage, travel, lodging and gaming services. In the context of transactions in these and other industries, it is common practice for a client or customer in to give a gratuity to the employee(s) with whom he has been dealing as thanks for personal services rendered.

The giving of gratuities in the context of gaming is also common practice for players, and is viewed by professional and amateur gamblers alike as a part of gaming culture. Such gratuities are usually offered in the context of specific circumstances, such as a player winning a substantial wager, or when a player or employee leaves a game after a period of sustained play. Many gamblers superstitiously believe that such gratuities not only serve as an reward to the employee to encourage good service, but also as an action or “good deed” helpful to generate or maintain good luck.

Gambling gratuities offered in the aftermath of a player's successful wager may be especially ample, as the player is likely to experience a psychological high from winning

Prior art discloses the use of gaming-related gratuities in certain limited contexts. For example, U.S. Pat. No. 6,626,757 to Oliveras discloses a computerized, live card game in which the central processing unit controls a means for tipping the dealer, and U.S. Pat. No. 7,833,101 to Lutnick et al., discloses a networked betting system including a secondary betting feature, wherein the secondary player may tip the primary player.

The rise of computerized and internet-driven gaming in recent years has created a gambling venue without the feature of human casino employees to whom gratuities may be directed. Thus, those online players for whom tipping is an understood function of gaming culture, or even a habit, currently have no option for paying gratuities.

Similarly, the number of online purchases of goods and services has grown steadily over the past decade. Total E-Commerce retail sales for “selected services” businesses (including entertainment, recreation, travel, technical, food service, financial services, etc.) more than doubled from under $65 billion in 2003 to over $146 billion in 2008. (See, U.S. Census Bureau, Service Annual Survey.) During the same period, electronic shopping for retail merchandise grew apace from approximately $46.4 billion to $106.8 billion. (See, U.S. Census Bureau, Annual Retail Trade Survey.) Thus the pool of potential commercial transactions during which gratuities or charitable donations might be solicited, received and/or forwarded is already enormous and growing.

Currently, many methods exist to donate to various types of charities, such as point of purchase donations, online donations, mail in donations, and so forth. Many organizations exist for the purpose of charitable and/or non-profit functions, including those organizations that qualify as charitable organizations under U.S. Internal Revenue Service (IRS) Regulation 501(c)(3).

Online donation systems also exist in prior art. For example, U.S. Patent Application No. 20110099102 to Leffew discloses a web-based donation system that is configured and operable to allow a sponsor to register or sign up one or more recipients to receive funds from donors. In another example, U.S. Pat. No. 6,898,575 to Mull discloses an electronic donor directed charitable donation system designed specifically for the WWW/Internet whereby donors can direct the disposition of donations. Participating charitable institutions can identify goods and services needed and donors can donate money to be applied for those specific needs by the institutions.

Similar systems are disclosed in prior art for the purposes of soliciting political donations in addition to charitable donations. For example, U.S. Pat. No. 7,870,067 to Crowl discloses a donation system that would encourage registered individuals to make small contributions to a charity or political campaign (or cause of their choice) as well as facilitate the process of doing so. The system provides a central location for all donation activity and works as a “contribution bundler” to empower those otherwise disempowered in the political marketplace.

Accordingly, there exists a need for an electronic commercial transaction system, in which the transaction is conducted concurrently with a solicitation for either a gratuity for the seller or a charitable donation to be forwarded to a third party beneficiary

### BRIEF SUMMARY OF THE INVENTION

Accordingly, there is provided, in preferred embodiments of the invention, methods and devices that include one or more of the following components:

First, an option presented to an online purchaser of goods or services, including but not limited to gaming services, to make a donation to a third party beneficiary such as a charitable organization, a political candidate or a political organization. Such offer could name a single potential beneficiary or a plurality of potential beneficiaries. The casino or other online business may offer this service for free or charge a fee.

Second, an option presented to an online purchaser of goods or services to pay a tip or gratuity to the online casino or business itself

In addition to online purchases, the disclosed system can also be used for purchases or gaming in which non-internet connected computer networks are utilized, either on-site at the point of purchase or otherwise.

In a preferred embodiment, a machine-accessible medium having associated instructions that, when accessed, comprise a system for the electronic payment of a gratuity or donation during an electronic commercial transaction between a buyer/customer and seller, comprising the steps of: (a) offering the customer the opportunity to make an electronic gift of a certain amount of money during the course of the electronic commercial transaction by electronically presenting in a graphical user interface an option to accept or decline the electronic gift, wherein the electronic gift is intended for a beneficiary selected from the seller or an employee of the seller as a gratuity, or one or a plurality of third party beneficiaries as a donation, and (b) electronically transmitting the electronic gift intended for the beneficiary to an account of such beneficiary.

In another preferred embodiment, method of providing an electronic system for making commercial transactions via the internet or another data network, comprising the steps of the preceding paragraph.

In another preferred embodiment, the machine-accessible medium of paragraph 32, wherein the commercial transaction is the playing of a game of chance, comprising the player making one or more wagers, including but not limited to blackjack, poker, craps, slots, sports bets, and any other casino-style game, jai alai, horse racing, dog racing, animal fights or human fights, as well as allow a player to wager on the outcome of an election or any event with uncertainty in the outcome including, but not limited to, crop results, weather, earthquakes, criminal trials, or any other event that might reasonably be wagered upon.

In another preferred embodiment, the machine-accessible medium of paragraph 32, wherein the commercial transaction is of a type that shares the pertinent chance and risk characteristics of gambling, including but not limited to (i) trading securities including but not limited to stocks, bonds, options, futures, commodities, mutual funds or derivatives; or (ii) the purchasing or holding of insurance policies.

In another preferred embodiment, the machine-accessible medium of paragraph 32, wherein the commercial transaction is a consignment-style or auction-style sale in which the entity controlling the electronic system is acting on behalf of a third party owner or seller.

In another preferred embodiment, the machine-accessible medium of paragraph 32, wherein the potential third party beneficiaries include, without limitation, charitable organizations, political campaigns or organizations, faith-based organizations, or other special interest or advocacy organizations.

In another preferred embodiment, the machine-accessible medium of paragraph 32, wherein the electronic gift is instead a segregation of customer funds into a separate, privately held financial account such as, without limitation, a checking account, savings account, money market account, credit card account, brokerage account, PayPal or similar web-based money account, individual retirement account or college savings account.

In another preferred embodiment, the machine-accessible medium of paragraph 32, wherein the protocol enabling the option to give a gratuity or donation is initiated upon one or more pre-set occurrences.

In another preferred embodiment, the machine-accessible medium of paragraph 34, wherein the protocol offering the player the option to give a gratuity or donation is initiated upon one or more pre-set occurrences, including, without limitation, (i) any time the player wins a wager; (ii) when the player's winnings increase his initial stake by a given percentage, (iii) when the player wins a wager or poker pot, (iv) when the player wins a certain number of pots, hands, spins or other game subsets, (v) upon the end of each hour or another time interval of play, (vi) upon any change in the type of game being played, (vii) upon the end of a given round of gaming, or (viii) upon exiting a game.

In another preferred embodiment, the machine-accessible medium of paragraph 32, wherein the protocol enabling the player to pre-set preferences is initiated before the commercial transaction begins.

In another preferred embodiment, the machine-accessible medium of the preceding paragraph, wherein the possible pre-set preferences include, without limitation, (i) whether solicitations for gratuities and/or donations will be made, (ii) when solicitations for gratuities and/or donations will be made, (iii) whether solicitations are accepted automatically or require manual acceptance, (iv) the amounts associated with solicitations or automatic payments, (v) the third party beneficiaries of any donations paid, and, (vi) if multiple beneficiaries are selected, the percentage of any donations paid to each such beneficiary.

In another preferred embodiment, the machine-accessible medium of paragraph 32, wherein a customer paying aggregate gratuities and/or donations in a pre-set amount initiates a protocol for rewarding such user with a prize consisting of a product or service of value, or with nonmonetary rewards such as electronic badges, certificates or markers.

In another preferred embodiment, the machine-accessible medium of paragraph 32, wherein one or more of the offers to make a gratuity or donation payment are constantly appearing to the customer during all steps of the transaction.

In another preferred embodiment, the machine-accessible medium of paragraph 32, wherein all payment(s) by the customer are enabled by customer inputting data allowing the host site to debit the appropriate amount from any privately held financial account, including but not limited to a checking account, savings account, brokerage account, credit card account, money market account or PayPal or similar web-based money account.

In another preferred embodiment, the machine-accessible medium of paragraph 32, wherein all donation payments received by the seller are electronically transferred to a segregated account for the designated beneficiary and subsequently electronically forwarded to an account owned by such beneficiary.

A machine-accessible medium having associated instructions that, when accessed, comprise a system for the electronic payment of a gratuity or donation during an electronic commercial transaction between a buyer/customer and seller, comprising the steps of: (a) offering the customer the opportunity to choose one or more of the following actions, either at pre-set intervals or constantly throughout such transaction, (i) give a gratuity to the seller or an employee of the seller, (ii) donate money to one or a plurality of third party beneficiaries, including, without limitation, charitable organizations, political campaigns or organizations, faith-based organizations or other special interest or advocacy organizations or (iii) transfer money to a privately held financial account including, without limitation, a checking account, savings account, money market account, credit card account, brokerage account, PayPal or similar web-based money account, individual retirement account or college savings account; (b) enabling customer to accept or decline the offer to make such gratuity and/or donation payment, (c) enabling the customer to make payment for purchased goods or services and any tip or donation amount chosen by the customer by inputting data allowing the host site to debit the appropriate amount from any privately held financial account, including but not limited to a checking account, savings account, brokerage account, credit card account, money market account or PayPal or similar web-based money account and, (d) electronically transferring any donations to a segregated account for the designated beneficiary and subsequently electronically forwarding such amounts to an account owned by such beneficiary.

In another preferred embodiment, method of providing an electronic system for making commercial transactions via the internet or another data network, comprising the steps of the preceding paragraph.

In another preferred embodiment, the machine-accessible medium of paragraph 47, wherein the commercial transaction is the playing of a game of chance, comprising the player making one or more wagers, including but not limited to blackjack, poker, craps, slots, sports bets, and any other casino-style game, jai alai, horse racing, dog racing, animal fights or human fights, as well as wagering on the outcome of an election or any event with uncertainty in the outcome including, but not limited to, crop results, weather, earthquakes, criminal trials, or any other event that might reasonably be wagered upon.

In another preferred embodiment, the machine-accessible medium of paragraph 47, wherein wherein the protocol enabling the option to give a gratuity or donation is initiated upon one or more pre-set occurrences.

In another preferred embodiment, the machine-accessible medium of paragraph 49, wherein the protocol offering the player the option to give a gratuity or donation is initiated upon one or more pre-set occurrences, including , without limitation, (i) any time the player wins a wager; (ii) when the player's winnings increase his initial stake by a given percentage, (iii) when the player wins a wager or poker pot, (iv) when the player wins a certain number of pots, hands, spins or other game subsets, (v) upon the end of each hour or another time interval of play, (vi) upon any change in the type of game being played, (vii) upon the end of a given round of gaming, or (viii) upon exiting a game.

### BRIEF DESCRIPTION OF THE DRAWINGS

FIG. 1 is a flow chart example of steps for soliciting a donation during an online poker game.

FIG. 2 is a flow chart example of steps for soliciting a gratuity during an online poker game.

FIG. 3 is a flow chart example of steps for soliciting a donation during an online retail sale.

### DETAILED DESCRIPTION OF THE INVENTION

The practice of tipping service providers, though widespread, his historically been limited to situations in which personal services are provided in a live format. Despite the rapid rise in retail sales of products and services on the internet, the practice of tipping in internet transactions is still largely if not entirely unknown. The failure of tipping to emerge in internet sales reflects the lack of a sense of personal or individual service in such transactions, as well as the lack of a method by which to offer a gratuity.

Definitions

The following definitions are provided as an aid to understanding the detailed description of the present invention.

“Gratuity” or “Tip” means money given to a person in return for some service or favor.

“Toke” means a gratuity given to an employee in a casino or gaming context, and is often applied to tips offered to casino employees such as dealers, slot machine attendants and keno runners.

The prevalence of tipping in certain service industries is well known. Service providers and professionals most known for receiving gratuities include restaurant wait staff, bartenders, hotel valets and taxi drivers.

Casino dealers, like bartenders, are a wealth of knowledge and usually are skilled conversationalists with the ability to offer good advice that could lead to winnings at the table. Casino workers sometimes call a player who tips heavily and/or often “George”, in reference to a one-dollar bill. There are two ways to toke a dealer. One is called a “hand in”, which means that the player directly tips the dealer. The other is placing a bet on the dealer's behalf. Many casinos allow the dealer to bet his or her tip with a player's hand and receive the usual payout if the player wins. When placing a toke bet for a dealer a common custom is to bet the next denomination down from the player's bet. For example, a player might bet $1 for the dealer concurrently with your own $5 bet. See, http://EzineArticles.com/5376973.

Players who opt to toke dealers or other casino employees can choose different circumstances or schedules to do so. Most common is the player who chooses to toke immediately after winning a large card game pot, blackjack bet, slot machine payout, roulette bet or similar situation. Some players will place a dealer bet each hour or so. Players will often also tip an exiting dealer when he or she is replaced during an ongoing game, or when the player himself leaves the game.

Casino dealers usually depend heavily on tokes for their livelihood. Depending on the region, casino dealers can make anywhere from $25,000 to more than $60,000 a year. But at most casinos, starting base pay for dealers is around $5.50 an hour—only $11,440 a year. The rest of a dealer's income comes from tokes. See, http://www.netplaces.com/casino-gambling/managing-your-money/tips-and-tokes.htm.

While tipping or toking is an integral part of the live casino experience, this part of gaming culture has not translated into the burgeoning online gaming industry. Unlike circumstances where tips have historically been given for directly offered personal services such as bringing refreshments, driving or dealing cards, an online gambler generally does not interact with an individual service provider.

That said, it should be noted that certain retail businesses do employ customer service representatives to engage directly with online customers, often in the context of assistance with faulty purchases or returns. Communications between such employees and customers often take place via a chat or instant messaging-style of exchange. In this situation, the prospect of a gratuity to an individual for personal services crosses the line into the internet context.

Despite the fact that there is usually no individual person is interacting with an online gaming player, such a player may nevertheless have a desire or incentive to make gratuity payments. Most notably, gamblers tend to be superstitious and prone to affectations that they deem to bring good luck. Such beliefs can be manifested in the wearing of lucky clothing, carrying good luck charms, or the offering of tokes.

The feeling of good luck associated with offering a toke is certainly enhanced when the player views the gratuity as going to a good cause. In live gaming, this cause is likely to be the livelihood of the recipient employee. In online gaming, this sense of doing a good deed can be replicated by replacing the concept of a gratuity with the concept of a charitable, political or other donation to a cause with which the donor identifies.

It should also be noted that the ascendency of internet gambling has also expanded the range of events on which a prospective player may wager well beyond casino-style games or sports betting. Examples, without limitation, of such events include elections, legislation, weather events, natural disasters and the outcomes of judicial trials. Without opining on the legality or morality of such wagering, it is accurate to state that a willing bettor can now place a wager on almost any regional or world event of importance via one or more internet-based gambling outlets.

In the context of online gaming, the timing of offers to pay a gratuity or a donation could be pre-set in the gaming software. Most broadly, such an offer could be made at each betting interval available to a player, although this level of frequency would likely be distracting and off-putting to the player. More palatable timing options might include, without limitation, after each win, after a pre-set number of wins, only upon a certain subset of wins, such as when money is doubled or when an all-in poker pot is won, when a pre-set dollar amount of winnings are realized, or when a pre-set percentage increase in portfolio or stake is realized.

Similarly, a wide range of different gratuity or donation sizes could be offered to the player. Possibilities for sizes could include, without limitation, a percentage of a wager, a percentage of an ante or blind bet as in poker, or a fixed amount ranging from a penny or less to the entire amount won.

As an alternative to a gaming business setting times and amounts for solicitation offers, players themselves could be allowed to pre-set such parameters for giving prior to beginning play, either at the time such a player sets up his user account, or upon the initiation of any particular gaming session. Another pre-set option for players could be which charity, political organization or other potential beneficiaries will be the recipient(s) of any donations made during future play.

The prospect of offering an online gratuity or charitable donation option to online customers also extends beyond the gaming industry. These features might particularly apply to other online service industries that exhibit similar chance and/or risk characteristics normally associated with gaming. For example, the trading of stocks, bonds, options, futures, commodities, mutual funds or other securities shares a commonality with traditional gambling in that the customer is placing a certain amount of money at risk in the hopes of capturing a future return. Thus companies that offer internet-based brokerage or other investing services are also potential users of a gratuity and/or donation function. As with a gambler who has just won a sizeable pot, an investor who has just cashed out a soaring stock holding may be psychologically predisposed to make a generous contribution at the same time.

Nor is the concept of a website-based gratuity and/or donation option limited to the financial services industry. Many supermarkets and other brick-and-mortar retailing businesses offer customers the option of making a donation at the register during checkout. The same offer could easily be made by any business selling any product or service during the online checkout process.

All features of timing of gratuity or donation offers and size possibilities, or allowing customers to pre-set giving preferences discussed above in the context of internet gaming players could also be made available to customers of online businesses in other industries.

Any e-business choosing to implement a gratuity and/or donation function to its online customer interface would have the potential to yield competitive and economic benefits. Gratuities paid to the business or to a service provider working directly with a customer via an online interface would increase revenues to the business and/or potentially reduce the salaries needed to retain customer service representatives. Perhaps more importantly, instituting a charitable donation feature in online sales or gaming transactions would serve to set a business apart from its competitors and portray the business in a positive light to potential customers. Such a feature could be actively marketed to increase customer awareness, satisfaction and traffic.

In a preferred embodiment, in a computerized or internet system for making a commercial transaction comprising the steps of (a) offering customers a product or service for sale; (b) enabling a customer to make an election to purchase such product or service; (c) upon the customer's election to purchase, offering the customer the opportunity to choose one or more of the following actions (i) tip the seller, (ii) donate money to one or a plurality of charitable organizations, political campaigns or organizations, faith-based organizations or other special interest or issue advocacy organizations, or (iii) transfer money to a privately held financial account, including but not limited to a checking account, savings account, brokerage account, PayPal or similar web-based money account, individual retirement account or college savings account; (d) enabling customer to accept or decline the offer (e) enabling customer to make payment for such good or service and the tip or donation pursuant to the customer's decisions.

In another preferred embodiment, the features of the described system wherein a donation or gratuity radio button or other, similar means of indicating acceptance is available to the customer throughout the transaction.

In another preferred embodiment, the features of the described system wherein payments made for the transaction and the gratuity or donation are made from the customer's site-specific account, or electronically from a third party account such as a savings account, checking account, PayPal or similar web-based money account, credit card account, brokerage account, or other, similar financial account.

In another preferred embodiment, the customer may be shown an avatar or other graphical representation of a fictional electronic helper to which the offer to make a gratuity or donation may be related. In a more preferred embodiment, such helper representation would include one or more trademarks or identifiers for one or more third party beneficiary entities. For example, such a helper representation might take the form of a human avatar wearing a t-shirt bearing the logo of a charitable organization.

In another preferred embodiment, the features of the described system applied to a gaming context, in which the system also executes the steps of a game of chance, including the placing of wagers, in lieu of the step of making a purchase.

In another preferred embodiment, the features of the described gaming system, wherein the system is integrated into live casino gaming via shared or individual networked devices. In such embodiment, the devices could take the form of a large display screen visible to all players at a table, with each player having access to individual response controls allowing, for example, the player to accept or decline offers to make a gratuity or donation payment.

In another preferred embodiment, the networked gaming system could comprise hybrid or streaming gaming, in which live gaming is shown to remote players in real time via the network and allows such players to wager on the live game as it occurs, either at an offsite location such as an off-track betting parlor, or through a mobile device including but not limited to a laptop computer, tablet computer or smartphone.

In another preferred embodiment, the player operating or interacting with the sales or gaming system would indicate preferences or answer prompts by using a computer mouse to click a radio button or any other commonly available means of communicating with a machine, such as shaking, turning or twisting a phone or game console remote control, making a hand gesture or other body gesture registered by a sensor, either on the body or located off the body, pushing an arrow key or hot key or any key on a physical keyboard or a graphical representation of a keyboard, tapping a lever or switch, turning a knob or any similar means of allowing a computer to determine the answer to the offer.

In another preferred embodiment, upon a customer paying aggregate gratuities and/or donations in a pre-set amount, the system would initiate a protocol for rewarding such user with a prize constituting a thing of value. Such rewards could include, without limitation, physical articles such as clothing, water bottles, mugs, hats, stickers, or similar goods, as well as account credits, frequent flier miles, points in any system operated by the seller towards free items of value, or the right to participate in free games, tournaments, sweepstakes or other contests in which items of value might be won.

In another preferred embodiment, at a pre-set time interval including but not limited to the end of each gaming session, monthly, semiannually or annually, the system would automatically generate and/or update one or more receipts for charitable or other donations made by the customer in a given tax year, such receipts generated in a format acceptable to the Internal Revenue Service, thereby allowing the customer to capture and use such receipts in preparing his or her tax returns. In a more preferred embodiment, such receipts generated in a format capable of importation into one or more tax preparation computer programs, such as TurboTax® or similar programs.

In another preferred embodiment, upon one or a plurality of actions by the customer, including without limitation initiating a new account, initiating, resuming, or ending play of a game, and initiating or completing a purchase transaction, the system would initiate a protocol presenting the user with a choice of one or more donation beneficiary options, including without limitation a single beneficiary or a list of multiple beneficiaries, and the option to spread any donation among multiple beneficiaries via pre-set percentages or other means of determining amounts to be given to each selected beneficiary.

In another preferred embodiment, the sales or gaming system would initiate the protocol for offering the right to give a gratuity and/or a donation according to preferences set by the customer or player prior to establishing a user account, making a purchase or playing a game, such preferences to include, without limitation, the beneficiary of the gratuity or donation, whether the payments will occur automatically or only upon the customer or player's acceptance of an offer, whether and how much to pre-set as a giving amount, and when to be presented with a giving offer.

In a more preferred embodiment, a customer or player would pre-set a preference wherein, upon the completion of each transaction, game or wager, a set percentage or fixed amount would be routed to a personal financial account as a method of saving.

In a more preferred embodiment, the gaming system would accept donations on behalf of third party beneficiaries by electronically transferring any such donated amount into a segregated account for such purpose, with the balance of such account being transferred to the beneficiary's designated account at an agreed-upon interval.

The methods described above may advantageously be implemented using a computer-based approach, and the present invention therefore includes a computer system for practicing the methods. A computer system comprises a number of internal components and is also linked to external components. The internal components include processor element interconnected with main memory. The external components include mass storage, e.g., one or more hard disks (typically of 1 GB or greater storage capacity). Additional external components include user interface device, which can be a keyboard and a monitor including a display screen, together with pointing device, such as a “mouse”, a touchpad, a touch-sensitive screen or monitor, or other graphic input device. The interface allows the user to interact with the computer system, e.g., to cause the execution of particular application programs, to enter inputs such as data and instructions, to receive output, etc. The computer system may further include a disk drive, CD drive, and/or other external drive for reading and/or writing information from or to external media respectively. Additional components such as DVD drives, USB ports, cloud storage on the internet, etc., are also contemplated.

The computer system is typically connected to one or more network lines or connections, which can be part of an Ethernet, wireless, cellular, direct cable, or similar link to other local computer systems, remote computer systems, or wide area communication networks, such as the Internet. This network link allows the computer system to share data and processing tasks with other computer systems and to communicate with remotely located users. The computer system may also include components such as a display screen, printer, etc., for presenting information.

A variety of software components, which are typically stored on mass storage, will generally be loaded into memory during operation of the inventive system. These components function in concert to implement the methods described herein. The software components include operating system, which manages the operation of computer system and its network connections. This operating system can be, e.g., a Microsoft Windows® operating system such as Windows Vista® or Windows 7®, a Macintosh operating system such as Leopard® or Snow Leopard®, a Unix or Linux operating system, an OS/2 or MS/DOS operating system, etc.

The software component is intended to embody various languages and functions present on the system to enable execution of application programs that implement the inventive methods. Such components include, for example, language-specific compilers, interpreters, and the like. Any of a wide variety of programming languages may be used to code the methods of the invention. Such languages include, but are not limited to, C (see, for example, Press et al., 1993, Numerical Recipes in C: The Art of Scientific Computing, Cambridge Univ. Press, Cambridge, or the Web site having URL www.nr.com for implementations of various matrix operations in C), C++, Fortran, JAVA™, various languages suitable for development of rule-based expert systems such as are well known in the field of artificial intelligence, etc. According to certain embodiments of the invention the software components include a Web browser, for interacting with the World Wide Web.

The software component represents the methods of the present invention as embodied in a programming language or languages of choice. In particular, the software component includes code to accept a set of activity measurements and code to estimate parameters of an approximation to a set of equations and steps representing a system for offering a gratuity or donation in the context of an electronically-conducted commercial transaction or wager. Additional software components to display the network model may also be included. The invention may also include one or more databases that contain sets of parameters for a plurality of different models, statistical packages, and other software components such as sequence analysis software, etc.

Thus the invention provides a computer system for constructing a system for offering a gratuity or donation in the context of an electronically-conducted commercial transaction or wager, the computer system comprising: (i) memory that stores a program comprising computer-executable process steps; and (ii) a processor which executes the process steps so as to construct a model of a commercial transaction system containing steps for soliciting and receiving gratuities or donations, and/or forwarding donations to third parties, the model comprising an approximation to a set of programmed process steps that represent the steps of selecting a product or service to purchase or a wager to make, select a gratuity or donation to pay and parameters for when to pay, making payments and, when appropriate, steps for playing a game or for inputting any necessary information to receive such product or service. According to certain embodiments of the invention the process steps estimate parameters of and select a structure for a model of a specific variety of transaction. The process steps may perform any of the inventive methods described herein. According to certain aspects of the invention rather than constructing the model, the computer system receives externally supplied instructions regarding purchases, payment, parameters for offering or making gratuity or donation payments, and parameters for rules or choices required to play a game (e.g., activity data), as entered by a user. The computer system uses the model, data and externally supplied instructions to accept orders for purchases, gratuity payments and donation payments. In a gaming context, the system also uses the model, data and externally supplied instructions to execute each step of the game and determine the winner(s) and amounts paid out for each game.

The invention further provides computer-executable process steps stored on a computer-readable medium, the computer-executable process steps comprising code to perform the methods herein. According to certain embodiments of the invention the computer-executable process steps comprise code to estimate parameters of and select a structure for a model of a system for offering a gratuity or donation in the context of an electronically-conducted commercial transaction. The code may implement any of the inventive methods described herein. The model may be displayed or presented to the user in any of a variety of ways. For example, the parameters may be displayed in tables, as matrices, as weights on a graphical representation of the network, etc.

The foregoing description is to be understood as being representative only and is not intended to be limiting. Alternative systems and techniques for implementing the methods of the invention will be apparent to one of skill in the art and are intended to be included within the accompanying claims. In particular, the accompanying claims are intended to include alternative program structures for implementing the methods of this invention that will be readily apparent to one of skill in the art.

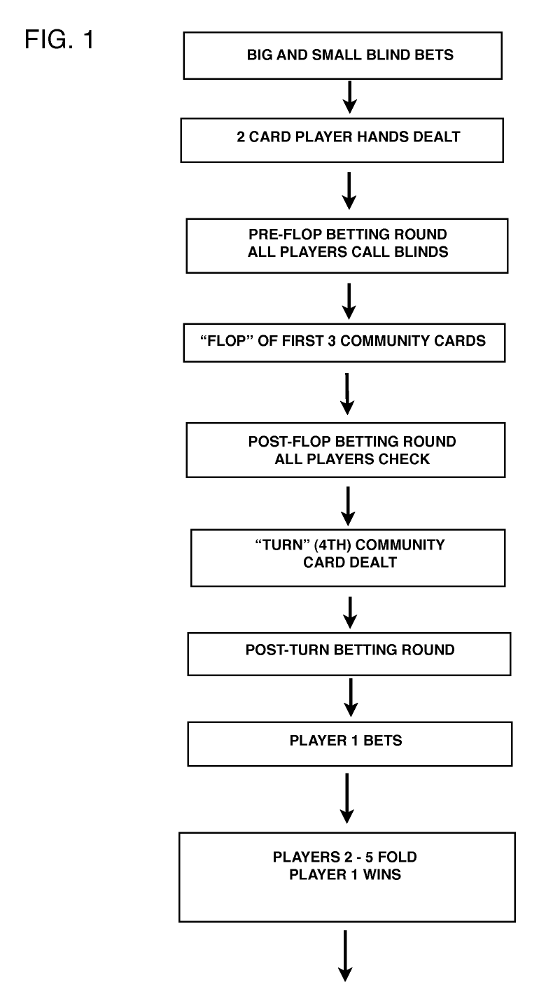

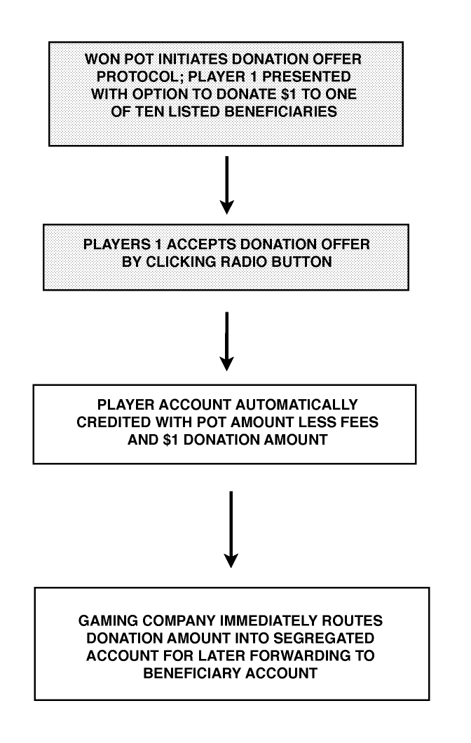

Referring now to the figures, FIG. 1 is a flow chart evidencing the following steps of an internet-based Texas hold'em poker game: (a) taking blind bets; (b) dealing player hands; (c) taking pre-flop bets; (d) dealing the first three dealer cards, (e) taking the next round of player bets; (f) dealing the fourth dealer card; (g) taking next round of player bets in which all players except for Player 1 fold; (h) presenting Player 1 with the option to donate to one of 10 listed beneficiaries; (i) allowing Player 1 to indicate acceptance of offer to donate $1 to a specific beneficiary, (j) crediting Player 1 account with the amount of the won pot, less fees and the $1 donation amount and (k) the $1 donation amount is routed to a segregated account for later forwarding to the designated beneficiary.

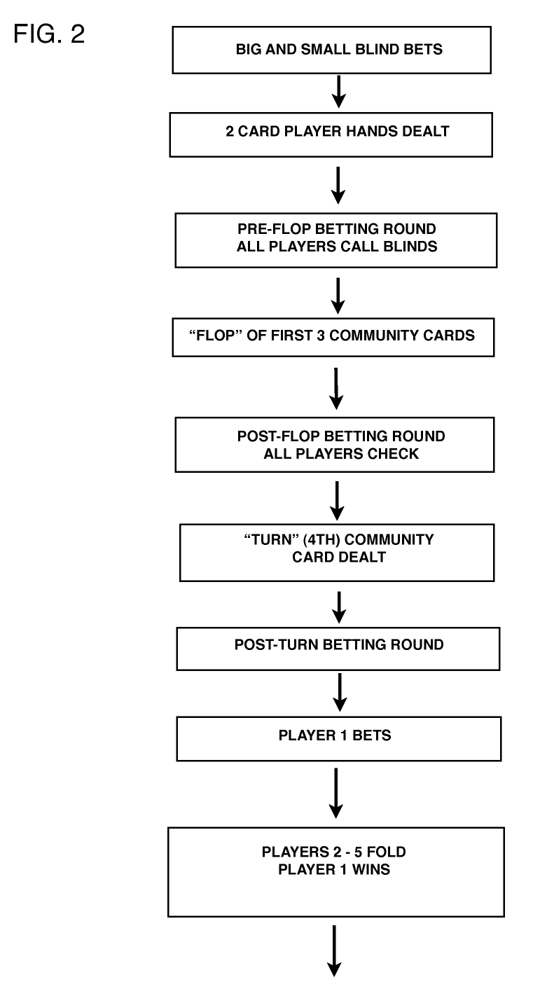

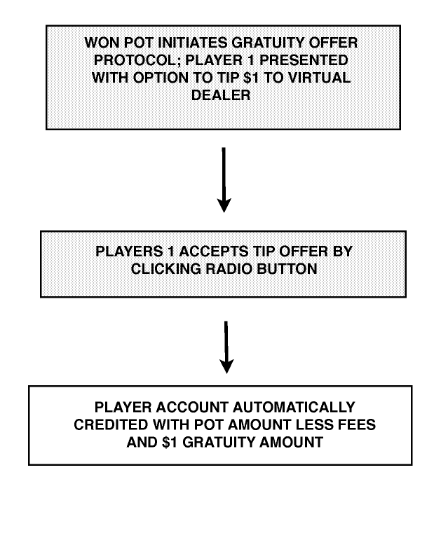

Referring now to the figures, FIG. 2 is a flow chart evidencing the following steps of an internet-based Texas hold'em poker game: (a) taking blind bets; (b) dealing player hands; (c) taking pre-flop bets; (d) dealing the first three dealer cards, (e) taking the next round of player bets; (f) dealing the fourth dealer card; (g) taking next round of player bets in which all players except for Player 1 fold; (h) presenting Player 1 with the option to tip the virtual dealer; (i) allowing Player 1 to indicate acceptance of offer to donate $1 to the virtual dealer and, (j) crediting Player 1 account with the amount of the won pot, less fees and the $1 gratuity amount.

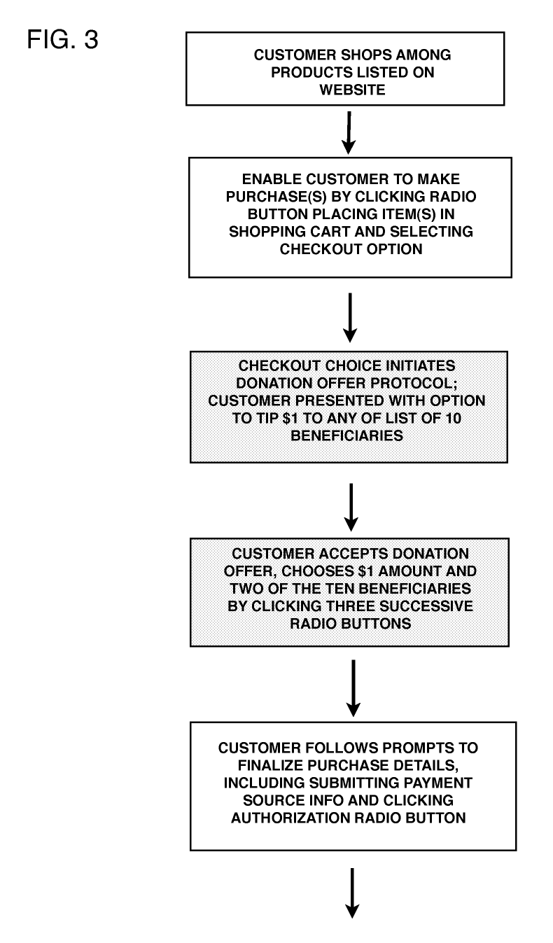

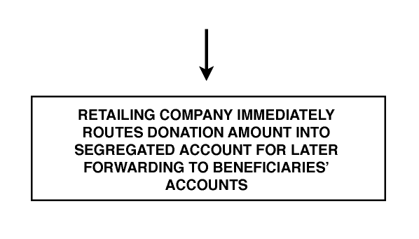

Referring now to the figures, FIG. 3 is a flow chart evidencing the following steps of an internet-based purchase transaction: (a) enabling customers to view one or a plurality of products and/or services for sale; (b) enabling a customer to place items in his shopping cart and select the checkout option; (c) offering the customer the opportunity to donate money to one or a plurality of third party beneficiaries, (d) enabling customer to (i) accept the offer to make a donation payment, (ii) choose the donation amount and (iii) choose to split that amount between two designated beneficiaries, (e) enabling the customer to make payment for the purchase plus the donation amount chosen by the customer and, (f) forwarding the donation marked for each third party beneficiary to a segregated account for later forwarding to the designated beneficiaries.

We claim:

1. A machine-accessible medium having associated instructions that, when accessed, comprise a system for the electronic payment of a gratuity or donation during an electronic commercial transaction between a buyer/customer and seller, comprising the steps of: (a) offering the customer the opportunity to make an electronic gift of a certain amount of money during the course of the electronic commercial transaction by electronically presenting in a graphical user interface an option to accept or decline the electronic gift, wherein the electronic gift is intended for a beneficiary selected from the seller or an employee of the seller as a gratuity, or one or a plurality of third party beneficiaries as a donation, and (b) electronically transmitting the electronic gift intended for the beneficiary to an account of such beneficiary.

2. A method of providing an electronic system for making commercial transactions via the internet or another data network, comprising the steps of claim 1.

3. The machine-accessible medium of claim 1, wherein the commercial transaction is the playing of a game of chance, comprising the player making one or more wagers, including but not limited to blackjack, poker, craps, slots, sports bets, and any other casino-style game, jai alai, horse racing, dog racing, animal fights or human fights, as well as allow a player to wager on the outcome of an election or any event with uncertainty in the outcome including, but not limited to, crop results, weather, earthquakes, criminal trials, or any other event that might reasonably be wagered upon.

4. The machine-accessible medium of claim 1, wherein the commercial transaction is of a type that shares the pertinent chance and risk characteristics of gambling, including but not limited to (i) trading securities including but not limited to stocks, bonds, options, futures, commodities, mutual funds or derivatives; or (ii) the purchasing or holding of insurance policies.

5. The machine-accessible medium of claim 1, wherein the commercial transaction is a consignment-style or auction-style sale in which the entity controlling the electronic system is acting on behalf of a third party owner or seller.

6. The machine-accessible medium of claim 1, wherein the potential third party beneficiaries include, without limitation, charitable organizations, political campaigns or organizations, faith-based organizations, or other special interest or advocacy organizations.

7. The machine-accessible medium of claim 1, wherein the electronic gift is instead a segregation of customer funds into a separate, privately held financial account such as, without limitation, a checking account, savings account, money market account, credit card account, brokerage account, PayPal or similar web-based money account, individual retirement account or college savings account.

8. The machine-accessible medium of claim 1, wherein the protocol enabling the option to give a gratuity or donation is initiated upon one or more pre-set occurrences.

9. The machine-accessible medium of claim 3 wherein the protocol offering the player the option to give a gratuity or donation is initiated upon one or more pre-set occurrences, including, without limitation, (i) any time the player wins a wager; (ii) when the player's winnings increase his initial stake by a given percentage, (iii) when the player wins a wager or poker pot, (iv) when the player wins a certain number of pots, hands, spins or other game subsets, (v) upon the end of each hour or another time interval of play, (vi) upon any change in the type of game being played, (vii) upon the end of a given round of gaming, or (viii) upon exiting a game.

10. The machine-accessible medium of claim 1, wherein the protocol enabling the player to pre-set preferences is initiated before the commercial transaction begins.

11. The machine-accessible medium of claim 10 wherein the possible pre-set preferences include, without limitation, (i) whether solicitations for gratuities and/or donations will be made, (ii) when solicitations for gratuities and/or donations will be made, (iii) whether solicitations are accepted automatically or require manual acceptance, (iv) the amounts associated with solicitations or automatic payments, (v) the third party beneficiaries of any donations paid, and, (vi) if multiple beneficiaries are selected, the percentage of any donations paid to each such beneficiary.

12. The machine-accessible medium of claim 1, wherein a customer paying aggregate gratuities and/or donations in a pre-set amount initiates a protocol for rewarding such user with a prize consisting of a product or service of value, or with nonmonetary rewards such as electronic badges, certificates or markers.

13. The machine-accessible medium of claim 1, wherein one or more of the offers to make a gratuity or donation payment are constantly appearing to the customer during all steps of the transaction.

14. The machine-accessible medium of claim 1, wherein all payment(s) by the customer are enabled by customer inputting data allowing the host site to debit the appropriate amount from any privately held financial account, including but not limited to a checking account, savings account, brokerage account, credit card account, money market account or PayPal or similar web-based money account.

15. The machine-accessible medium of claim 1, wherein all donation payments received by the seller are electronically transferred to a segregated account for the designated beneficiary and subsequently electronically forwarded to an account owned by such beneficiary.

16. A machine-accessible medium having associated instructions that, when accessed, comprise a system for the electronic payment of a gratuity or donation during an electronic commercial transaction between a buyer/customer and seller, comprising the steps of: (a) offering the customer the opportunity to choose one or more of the following actions, either at pre-set intervals or constantly throughout such transaction, (i) give a gratuity to the seller or an employee of the seller, (ii) donate money to one or a plurality of third party beneficiaries, including, without limitation, charitable organizations, political campaigns or organizations, faith-based organizations or other special interest or advocacy organizations or (iii) transfer money to a privately held financial account including, without limitation, a checking account, savings account, money market account, credit card account, brokerage account, PayPal or similar web-based money account, individual retirement account or college savings account; (b) enabling customer to accept or decline the offer to make such gratuity and/or donation payment, (c) enabling the customer to make payment for purchased goods or services and any tip or donation amount chosen by the customer by inputting data allowing the host site to debit the appropriate amount from any privately held financial account, including but not limited to a checking account, savings account, brokerage account, credit card account, money market account or PayPal or similar web-based money account and, (d) electronically transferring any donations to a segregated account for the designated beneficiary and subsequently electronically forwarding such amounts to an account owned by such beneficiary.

17. A method of providing an electronic system for making commercial transactions via the internet or another data network, comprising the steps of claim 16.

18. The machine-accessible medium of claim 16, wherein the commercial transaction is the playing of a game of chance, comprising the player making one or more wagers, including but not limited to blackjack, poker, craps, slots, sports bets, and any other casino-style game, jai alai, horse racing, dog racing, animal fights or human fights, as well as wagering on the outcome of an election or any event with uncertainty in the outcome including, but not limited to, crop results, weather, earthquakes, criminal trials, or any other event that might reasonably be wagered upon.

19. The machine-accessible medium of claim 16, wherein wherein the protocol enabling the option to give a gratuity or donation is initiated upon one or more pre-set occurrences.

20. The machine-accessible medium of claim 18 wherein the protocol offering the player the option to give a gratuity or donation is initiated upon one or more pre-set occurrences, including, without limitation, (i) any time the player wins a wager; (ii) when the player's winnings increase his initial stake by a given percentage, (iii) when the player wins a wager or poker pot, (iv) when the player wins a certain number of pots, hands, spins or other game subsets, (v) upon the end of each hour or another time interval of play, (vi) upon any change in the type of game being played, (vii) upon the end of a given round of gaming, or (viii) upon exiting a game.
